(19) United States
(12) Patent Application Publication
(10) Pub. No.: US 2008/0073983 A1
(43) Pub. Date: Mar. 27, 2008

(54) RESILIENT MOTOR MOUNTING SYSTEM AND METHOD OF USE

(76) Inventor: DEZI KRAJCIR, Dunnville, CA (US)

Correspondence Address: Mark A. Koch;Professional Corporation, 583 Main Street East, Hamilton, ON, L8M 1J4, US

(21) Appl. No.: 11/855,226

(22) Filed: Sep. 14, 2007

Related U.S. Application Data
(60) Provisional application No. 60/826,405, filed on Sep. 21, 2006.

(51) Int. Cl. H02K 5/24; F16F 7/00; F16M 1/04

(52) U.S. Cl. 310/51; 248/560; 248/603; 310/91

(57) ABSTRACT

A resilient motor mounting system for use with electric motors including a resilient motor mount including at least two resilient vanes moveable between a collapsed position and an extended position, wherein each vane including a fixed end and a free end, wherein the fixed end rigidly attached to the motor, wherein each vane projecting radially away from the motor such that the free end for resiliently biased against a mounting surface thereby securely holding the motor in a desired stationary position. Each vane preferably defining a curved shape such that the radius of curvature is increased to urge the vane into the collapsed position and the radius of curvature is decreased as the vane is released into the extended position.

The present application claims the benefit of previously filed U.S. Provisional Application 60/826,405 flied Sep. 21, 2006 under the title RESILIENT MOTOR MOUNTING SYSTEM AND METHOD OF USE by DEZI KRAJCIR.

### FIELD OF THE INVENTION

The present invention relates to methods of mounting electrical and other motors and more particularly relates to a resilient motor mounting system and its method of use.

### BACKGROUND OF THE INVENTION

A number of existing motor mounting techniques have been patented and as well are presently in commercial usage. Most of the existing and patented motor mounting techniques include rigid flanges and brackets which are bolted onto the motor and then permanently fastened to the frame work and/or to the housing to which the motor is to be mounted in. There are many instances where replacement of motors occurs on a regular basis and the process and procedure for the removal and re-installation of a new motor can be very time consuming and cumbersome. In some instances these motors are located in very tight spaces which are difficult to access and require removal and disassembly of frame work and/or duct work and/or other mounting brackets and other structures before it is even possible to access the motor itself. In addition, the replacement motor is often not available in exactly the same configuration as the existing motor and therefore on site modifications to the mounting system of the motor must often be made. These on site modifications are often very time consuming and costly and resulting in large amounts of down time.

Therefore, there is a need for a system for mounting and dismounting electrical motors and other types of motors which can be quickly and simply accomplished without special tools and particularly can be accomplished in areas where there is restricted access to the motor.

### SUMMARY OF THE INVENTION

A resilient motor mounting system for use with electric motors comprising:
a) a resilient motor mount including at least two resilient vanes moveable between a collapsed position and an extended position,
b) wherein each vane including a fixed end and a free end, wherein the fixed end rigidly attached to the motor,
c) wherein each vane projecting radially away from the motor such that the free end for resiliently biased against a mounting surface thereby securely holding the motor in a desired stationary position.

The resilient motor mounting system wherein each vane defining a curved shape such that the radius of curvature is increased to urge the vane into the collapsed position and the radius of curvature is decreased as the vane is released into the extended position.

The resilient motor mounting system wherein each vane including at least two vane elements which are connected together at the fixed end and the free end to form a unity resilient vane.

The resilient motor mounting system wherein each resilient vane connected at the fixed end to the outer diameter of the motor case.

The resilient motor mounting system wherein at least two resilient motor mounts are attached in spaced apart relationship to the motor casing of the motor.

A resilient motor mounting system for use with electric motors comprising:
a) A resilient motor mount including at least two groups of resilient vanes moveable between a collapsed position and an extended position,
b) wherein each vane including a fixed end and a free end, wherein the fixed end rigidly attached to the motor,
c) wherein each grouping including at least two independent vanes mounted side by side in close proximity to each other,
d) wherein each vane projecting radially away from the motor such that the free end for resiliently biasing against a mounting surface thereby securely holding the motor in a desired stationary position.

The resilient motor mounting system wherein at least two resilient motor mounts are attached to motor casing of the motor.

In combination a resilient motor mount, an electric motor and a housing comprising;
a) wherein the resilient motor mount including at least two resilient vanes moveable between a collapsed position and an extended position,
b) wherein each vane including a fixed end and a free end, wherein the fixed end rigidly attached to the motor,
c) wherein each vane projecting radially away from the motor such that the free end is resiliently biased against the housing in the extended position thereby securely holding the motor within the housing.

The combination wherein the housing being a cylindrical housing.

The combination wherein the motor being a fan motor and the housing dimensioned to house the fan therein.

The combination wherein each vane defining a curved shape such that the radius of curvature is increased to urge the vane into the collapsed position and the radius of curvature is decreased as the vane is released into the extended position.

The combination wherein each vane including at least two vane elements which are connected together at the fixed end and the free end to form a unitary resilient vane.

### BRIEF DESCRIPTION OF THE DRAWINGS

The invention will now be described by way of example only with reference to the following drawings in which:

FIG. 1 is a side elevational view of a resilient motor mount deployed on a motor which is installed in a housing shown in a collapsed position in solid lines and in a partially extend position and fully extended position in dashed lines.

FIG. 2 is a side partial cut away view of a motor together with the resilient motor mount shown in the collapsed position mounted within a housing.

FIG. 3 a side elevational view shows schematically the resilient motor mount in an extended position mounted within a housing.

FIG. 4 is a partial schematic cut away of a motor together with the resilient motor mount shown in the extended position mounted within a housing.

FIG. 5 is a schematic perspective view of a motor together with the resilient motor mount attached thereon showing fan blades in dotted lines mounted onto a motor shaft.

FIG. 6 shows a typical installation of the resilient motor mount showing the motor mounted within a housing in an extended position.

FIG. 7 is an end elevational view of a motor together with an alternate embodiment of the resilient motor mount shown installed in a housing.

FIG. 8 is a side schematic perspective view of the resilient motor mount shown in FIG. 7 without the housing.

FIG. 9 is a schematic perspective view of the motor mount shown in FIG. 8 mounted in a housing.

FIG. 10 is a end elevational view of an alternate embodiment of the resilient motor mount shown together with a motor in a housing.

FIG. 11 is a schematic perspective view of the resilient motor mount shown in FIG. 10 without the housing.

FIG. 12 is a schematic perspective view of the resilient motor mount shown in FIG. 10 together with the housing.

FIG. 13 is a schematic perspective view of a resilient motor mount as depicted in FIGS. 7, 8 and 9 shown deployed within a housing which in turn is deployed within a frame work and attached to duct work.

### DETAILED DESCRIPTION OF THE PREFERRED EMBODIMENT

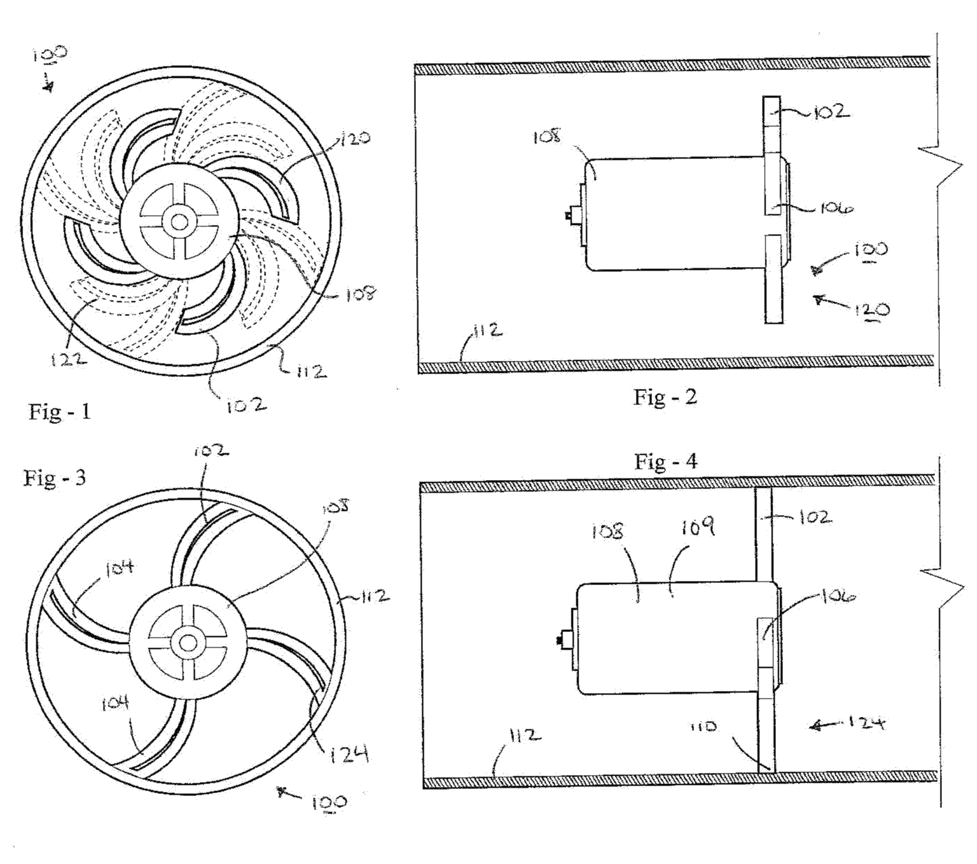

The resilient motor mounting system and method of use is depicted in FIGS. 1 through 13 and in particular the first embodiment of resilient motor mount 100 is shown in FIGS. 1 through 6. Resilient motor mount 100 includes resilient vanes 102 which may be comprised of a number of vane elements 104 which are attached at a fixed end 106 to the outer diameter of motor case 109 of motor 108 and demountable at a vane free end 110 for mounting onto a mounting surface such as for example a housing 112. As shown in FIGS. 1 through 6, the fixed end 106 of each resilient vane 102 is rigidly connected to the outside diameter of motor 108 and they project radially away from motor 108 in a curved fashion as shown in FIGS. 1 through 6. In the embodiment shown in FIGS. 1 through 6, each resilient vane 102 is comprised of two vane elements 104 which are normally connected together at the vane free end 110 and also at the vane fixed end 106. Each vane includes at least two vane elements which are connected together at the fixed end and the free end to form a unitary resilient vane.

Each resilient vane 102 can be resiliently compressed independently to as shown in the collapsed position 120 in FIG. 1 and also in FIG. 2. Each resilient vane 102 can also be extended to a partially extended position 122 as shown in FIG. 1 and to a fully extended position as shown in FIG. 124.

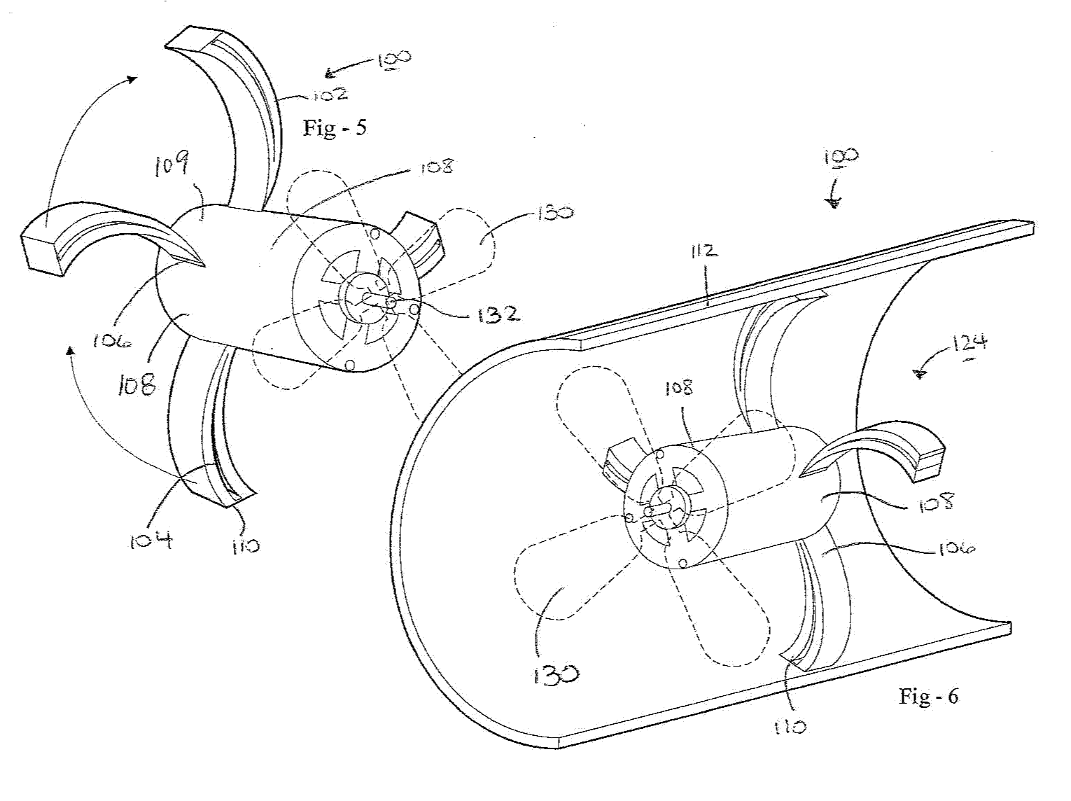

In FIGS. 5 and 6, the motor 108 is deployed as a fan and the diagrams show fan blades 130 attached to a motor shaft 132 of motor 108. In this example, motor 108 is mounted within housing 112, wherein the resilient vanes 102 are shown in the extended position 124 in FIG. 6.

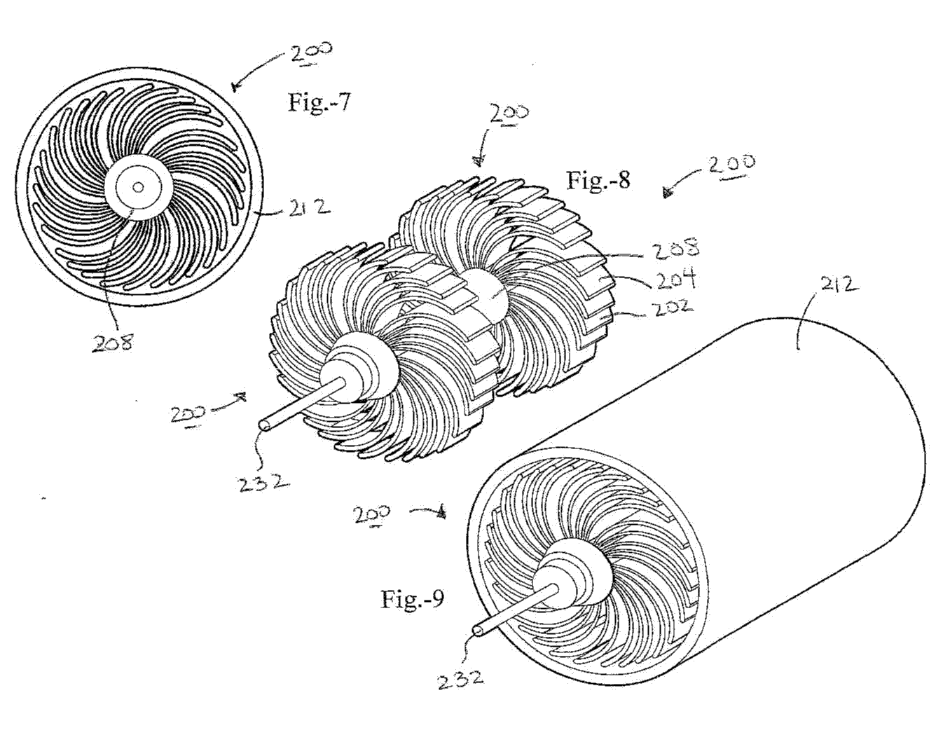

FIGS. 7, 8 and 9 shown an alternate embodiment of resilient motor mount namely 200 which is comprised of a number of vane elements namely, resilient vanes 202 each of which also being a vane element 204. In this particular embodiment each flexible vane 202 is comprised of one vane element 204, whereas in the previous embodiment resilient vane 102 was comprised of two of the vane elements 104 attached at the vane free end 110 and the vane fixed end 106.

In the present embodiment there are two resilient motor mounts 200 mounted onto motor 208. In this case the resilient motor mounts 200 are mounted onto each end of motor 208 to provide for a symmetrical distribution of the holding force maintaining the motor 208 in position within the housing 212 by positioning and holding firmly both ends of motor 208.

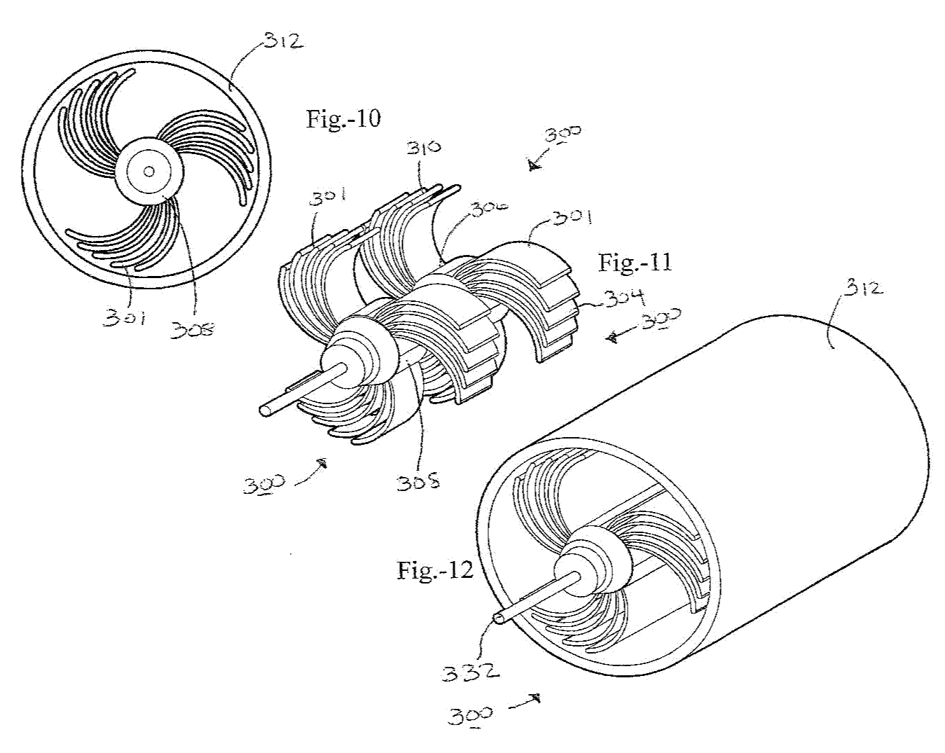

Figure now to FIGS. 10, 11 and 12, yet another alternate embodiment shown generally as resilient mount 300 which is comprised of group of vanes 301, wherein each group of vanes 301 is made up of a number of vane elements 304 which are attached at fixed end 306 to motor 308.

Unlike the first embodiment in which each resilient vane 102 was comprised of two vane elements 104 which were rigidly connected at the vane free end 110 and the vane fixed end 106. In this embodiment, resilient motor mount 300 is comprised of a number of group of vanes 301 which are comprised of a number of vane elements 304 which in the diagrams show that each group of vanes 301 is comprised of five vane elements 304 which are not connected at the vane free end 310. FIG. 11 shows the resilient motor mount 300 positioned inside a housing 312, wherein motor 308 shows a motor shaft 332 projecting outwardly there from.

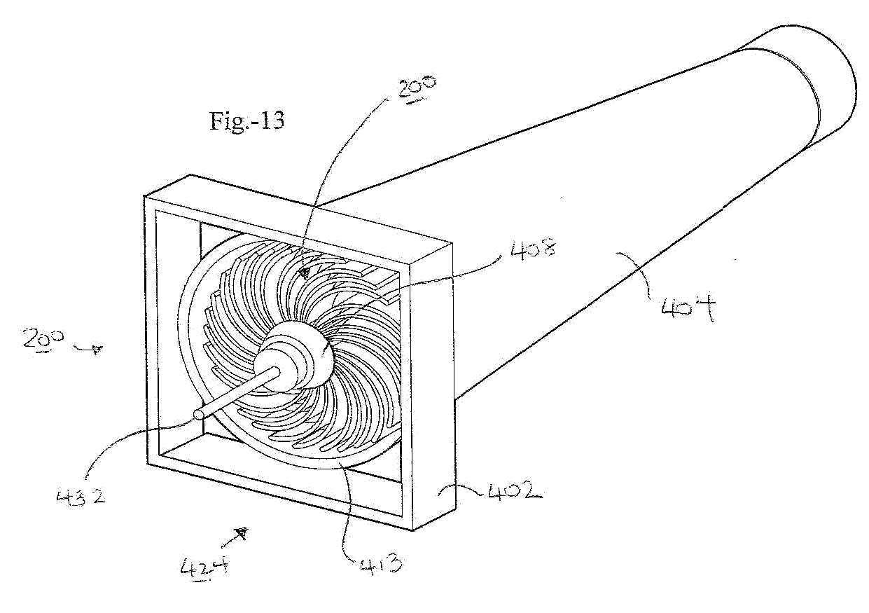

Referring now to FIG. 13 which shows resilient motor mount 200 mounted within a housing 213, wherein housing 213 is rigidly attached to a frame work 402 which in turn is connected to duct work 404, wherein the resilient motor mount 200 is shown in the extended position 424. Resilient motor mount 200 holds motor 408 which include a motor shaft 432 rigidly and concentrically within housing 413 as shown in FIG. 13.

In use resilient motor mount 100, 200 and 300 are used in analogous fashion. By way of example only we will describe use of motor mount 100 with reference to FIGS. 1 through 6. The method and application of use can be analogously applied to resilient motor mount 200 as well as resilient motor mount 300. A person skilled in the art will note that resilient motor mount 100, 200 and 300 are very similar aside from the fact that the groupings and spacings of the vane elements 104 and their attachment are somewhat different.

Referring now to FIGS. 1 through 6, resilient motor mount 100 is firstly placed into a collapsed position 120 by compressing manually or by using a suitable tool, the resilient vanes 102. Resilient vanes 102 collapse in resilient spring like fashion by coiling downwardly by bending each resilient vane 102 towards the motor 108. The radius of curvature of each vane is increased as one urges the vane into the collapsed position and the radius of curvature is decreased as the vane is released into the extended position.

In this manner the outer notional diameter and/or radius defined by the distance of the vane free end 110 from motor 108 is minimized and/or significantly reduced from the notional outer radius and/or diameter defined by the vane free ends 110 in the extended position 124.

In collapsed position 120, the motor 108 can be placed within the housing 112 in which the motor 108 is to be mounted in. Once the resilient vanes 102 are released, they resiliently bias against the inner diameter of housing 112, thereby mounting motor 108 in a fixed position within housing 112 simply due to the resilient bias of the resilient vanes 102 against the inner wall of housing 112.

A person skilled in the art will note that replacement, removal and insertion of a new motor becomes a simple task of collapsing resilient vanes 102 into collapsed position 120, whereby the motor 108 can be removed and/or installed into the desired position within housing 112.

A number of resilient motor mounts 100 can be attached to the outer diameter or outer casing of motor 108 and as shown and depicted in FIGS. 1 through 6. Resilient motor mount 100 is attached to the outer diameter of motor 108. In FIGS. 7, 8 and 9 two resilient motor mounts 200 are mounted onto the outer diameter of motor 208. In FIGS. 10, 11 and 12, the third embodiment namely resilient motor mount 300 also shows two resilient motor mounts mounted onto motor 308. The number or the arrangement of the resilient motor mounts onto the outer diameter of motor 308, will depend upon the application and the geometry of the installation.

Note that the drawings do not indicate particular attachment means for fixing the fixed end 106 of each resilient vane 102 to the outside diameter of motor 108. There are many different mounting means available that are known in the art including for example, rigidly connecting the vane fixed end 106 with suitable fasteners to a circular clamp which in turn can then be clamped around the outside of motor 108 thereby holding each of the resilient vanes 102 rigidly onto the outer diameter of motor 108.

The resilient vanes 102 may be integrally part of the motor casing of motor 108 for motors which are designed from the ground up and are designed to include this mounting method and/or mounting means from the inception and design of the motor itself.

There may be methods of mounting resilient vanes 102 onto motor 108 for retrofitting existing motors which may include circular clamps and/or other clamping and/or flange techniques and/or attachment techniques for rigidly attaching resilient vanes 102 to motor 108.

The resilient motor mounting system can be used for existing fan installations and also for newly designed installations. By way of example and without limitation this technology can used in existing or new ductwork, automobile installations, aircraft and spacecraft installations, in greenhouses, residential and commercial buildings. It may be possible to eliminate large plenums and fan boxes by using this technology and it may also provide greater design freedom in selecting locations for fan installations. The fan location may improve efficiencies since it may be possible to pull air rather than push it in a given installations. Thus mounting method is not limited to fan motors but also may be successfully employed for other motor installations. For example it may be possible to use the resilient motor mounting system for drive motors.

It should be apparent to persons skilled in the arts that various modifications and adaptation of the structure described above are possible without departure from the spirit of the invention, the scope of which defined in the appended claims.

I claim:

1) A resilient motor mounting system for use with electric motors comprising:
a) a resilient motor mount including at least two resilient vanes moveable between a collapsed position and an extended position,
b) wherein each vane including a fixed end and a free end, wherein the fixed end rigidly attached to the motor,
c) wherein each vane projecting radially away from the motor such that the free end for resiliently biased against a mounting surface thereby securely holding the motor in a desired stationary position.

2) The resilient motor mounting system claimed in claim 1 wherein each vane defining a curved shape such that the radius of curvature is increased to urge the vane into the collapsed position and the radius of curvature is decreased as the vane is released into the extended position.

3) The resilient motor mounting system claimed in claim 1 wherein each vane including at least two vane elements which are connected together at the fixed end and the free end to form a unitary resilient vane.

4) The resilient motor mounting system claimed in claim 1 wherein each resilient vane connected at the fixed end to the outer diameter of the motor case.

5) The resilient motor mounting system claimed in claim 1 wherein at least two resilient motor mounts are attached in spaced apart relationship to the motor casing of the motor.

6) A resilient motor mounting system for use with electric motors comprising:
a) A resilient motor mount including at least two groups of resilient vanes moveable between a collapsed position and an extended position,
b) wherein each vane including a fixed end and a free end, wherein the fixed end rigidly attached to the motor,
c) wherein each grouping including at least two independent vanes mounted side by side in close proximity to each other,
d) wherein each vane projecting radially away from the motor such that the free end for resiliently biasing against a mounting surface thereby securely holding the motor in a desired stationary position.

7) The resilient motor mounting system claimed in claim 6 wherein at least two resilient motor mounts are attached to motor casing of the motor.

8) In combination a resilient motor mount, an electric motor and a housing comprising;
a) a resilient motor mount including at least two resilient vanes moveable between a collapsed position and an extended position,
b) wherein each vane including a fixed end and a free end, wherein the fixed end rigidly attached to the motor,
c) wherein each vane projecting radially away from the motor such that the free end is resiliently biased against the housing in the extended position thereby securely holding the motor within the housing.

9) The combination claimed in claim 8 wherein the housing being a cylindrical housing.

10) The combination claimed in claim 8 wherein the motor being a fan motor and the housing dimensioned to house the fan therein.

11) The combination claimed in claim 8 wherein each vane defining a curved shape such that the radius of curvature is increased to urge the vane into the collapsed position and the radius of curvature is decreased as the vane is released into the extended position.

12) The combination claimed in claim 8 wherein each vane including at least two vane elements which are connected together at the fixed end and the free end to form a unitary resilient vane.
